(19) United States
(12) Patent Application Publication
(10) Pub. No.: US 2003/0211844 A1
(43) Pub. Date: Nov. 13, 2003

(54) System and method for automatically changing user data

(75) Inventor: Manami Omori, Tokyo (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 10/434,654

(22) Filed: May 9, 2003

(30) Foreign Application Priority Data
May 9, 2002 (JP) 133611/2002

(51) Int. Cl. H04M 3/42

(52) U.S. Cl. 455/414.2; 455/412.1; 455/414.1

(57) ABSTRACT

A system automatically changes the user data such as e-mail address registered in reception designation lists used in a reception designation service according to notification of user data change. Reception designation service lists are provided for storing user data of each of users of a reception designation service. A first server has a capability of sending a notification of user data change according to a request from a terminal device of a user, the notification containing a change from a former user data to a new one. A second server has a capability of receiving the notification and changing the former user data to the new one in a corresponding one of the lists to the terminal device according to the notification. When the corresponding one of the lists is set to be changeable, the second server changes automatically the former user data to the new one in the corresponding one of the lists.

### BACKGROUND OF THE INVENTION

1. Field of the Invention

The present invention relates to a system and a method for automatically changing user data, such as the electronic-mail (e-mail) address, telephone number, and so on. More particularly, the invention relates to a system and a method for automatically changing user data in a reception designation list, in which when a user of a mobile terminal device having a data communication facility notifies a corresponding telecommunications service provider the change of his/her user data, the change of the user data can be automatically reflected in a reception designation list or lists for a desired person or persons registered in a reception designation service.

2. Description of the Related Art

In recent years, mobile or portable electronic devices such as portable or cellular telephones have become capable of not only voice communication but also data communication by way of network. Mobile electronic devices of this type are connectable to a communication network (e.g., the Internet) by radio and therefore, they can transmit and/or receive e-mail messages.

However, as the use of e-mail has spread widely, unwanted direct-mail advertising messages have been frequently transmitted by e-mail to the devices of this type. To avoid reception of such unwanted messages in advance, the users usually change the e-mail address for their devices.

When a user of the mobile device of this type changes the e-mail address for his/her device, the user needs to immediately notify his/her new e-mail address to the people concerned (e.g., friends and acquaintances). In this case, it is usual that a small number of addresses can be designated as the recipient's address of each e-mail message in the mobile device of this type. Therefore, there is a disadvantage that notification of the e-mail address change of the said user to the people concerned by e-mail requires lots of time and labor if the total number of the addresses (i.e., the people concerned) to be notified is large.

Also, the notification of the e-mail address change by e-mail causes another disadvantage that the load for the communication network itself is increased. This is because many e-mail messages are simultaneously transmitted to many people for each individual change.

Moreover, when the people concerned receive the notification of the e-mail address change, they need to rewrite their address lists or telephone books stored and managed in their mobile electronic devices such as mobile telephones. This rewriting operation is usually conducted manually and thus, there is a further disadvantage that they have to conduct such a time-consuming and troublesome operation whenever they receive the notification of change of the e-mail address or other user data.

To overcome these disadvantages, several measures have been developed and disclosed. For example, the Japanese Non-Examined Patent Publication No. 2001-245050 published on Sep. 7, 2001 discloses a mobile communication system comprising mobile terminals each having a telephone book, a data transmission/reception capability, and an identification number; exchanges for establishing communication lines among the terminals; and communication lines for interconnecting the exchanges. The exchanges and the communication lines constitute a wired network. A home location register, a data receiving means, and a data transmitting means are provided in the network.

The home location register stores an identification (ID) number of one (i.e., a former ID number) of the terminals replaced with a new mobile terminal and an ID number of the new terminal in such a way that these two ID numbers of the former and new terminals are related with each other. The data receiving means receives the data of other ID numbers registered in a telephone book of the said former or new terminal. The data transmitting means transmits the ID number of the new terminal to each of the terminals corresponding to the said other ID numbers. Thereafter, each of the terminals registers the ID number of the new terminal, which has been transmitted by the data transmitting means, in its own telephone book.

With the mobile communication system disclosed by the Publication No. 2001-245050, the user data (i.e., the ID number of a new mobile terminal) can be renewed in each of the mobile terminals when a user replaces his/her mobile terminal with a new one.

In recent years, a “reception designation service” has been provided by a telecommunications service provider, where (i) reception of undesired incoming e-mail messages (i.e., annoying e-mail messages) is selectively refused and/or (ii) reception of incoming e-mail messages transmitted from permitted e-mail addresses is selectively allowed. This selection is carried out according to the registration in the reception designation list of each user of the said service. In this service, the sender's address of e-mail messages arriving at a mail server (a server computer for handling transmission and reception of e-mail messages) of the provider is checked and selected before transmitting or forwarding them to their recipients' addresses. Thereafter, only the messages thus selected are transmitted or forwarded to their recipient' addresses.

If the above-described mobile communication system disclosed by the Publication No. 2001-245050 is applied to the above-described “reception designation service”, there arises a disadvantage that the change of an e-mail address must be reflected in the reception designation list of each of the users concerned by way of a specific procedure (e.g., accessing a server of the said provider, connecting his/her mobile terminal device to the server by radio, and conducting a set of processes for changing the related e-mail address in his/her reception designation list).

In addition, the Japanese Non-Examined Patent Publication No. 2002-55926 published on Feb. 20, 2002 discloses an e-mail reception notification system. In this system, if a user transmits an e-mail message including a reception notice condition to a server device, the server device detects the reception notice condition and registers the same. When the server device receives an e-mail message addressed to the said user and detects the fact that the message satisfies the reception notice condition, a reception notice is transmitted to the said user and then, the reception notice condition is changed.

However, the e-mail reception notification system disclosed in the Publication No. 2002-55926 is a system for simply notifying the e-mail reception to the users addressed in the arriving e-mail messages. Therefore, this system is clearly different from a system and a method for automatically changing user data like the invention.

### SUMMARY OF THE INVENTION

Accordingly, an object of the present invention is to provide a system and a method for automatically changing user data that make it possible to automatically change user data (e.g., e-mail address and/or telephone number) registered in a reception designation list of each related users of a reception designation service according to notification of change of user data.

Another object of the present invention is to provide a system and a method for automatically changing user data that make it unnecessary to conduct a specific procedure for changing user data (e.g., e-mail address and/or telephone number) registered in a reception designation list of each related users of a reception designation service when a change of user data is notified.

The above objects together with others not specifically mentioned will become clear to those skilled in the art from the following description.

According to a first aspect of the present invention, a system for automatically changing user data in a reception designation service is provided, which comprises:

reception designation service lists for storing user data of each of users of a reception designation service;

a first server having a capability of sending a notification of user data change according to a request from a terminal device of a user, the notification containing a change from a former user data to a new user data; and

a second server having a capability of receiving the notification and of changing the former user data to the new user data in a corresponding one of the lists to the terminal device according to the notification;

wherein when the corresponding one of the lists is set to be changeable, the second server changes automatically the former user data to the new user data in the corresponding one of the lists.

With the system for automatically changing user data in a reception designation service according to the first aspect of the present invention, reception designation service lists are provided for storing user data of each of users of a reception designation service. A first server has a capability of sending a notification of user data change according to a request from a terminal device, the notification containing a change from a former user data to a new user data. A second server has a capability of receiving the notification and of changing the former user data to the new user data in a corresponding one of the lists according to the notification. When the corresponding one of the lists is set to be changeable, the second server changes automatically the former user data to the new user data in the corresponding one of the lists.

Accordingly, user data (e.g., e-mail address and/or telephone number) registered in the reception designation list of each related user of the reception designation service can be automatically changed according to notification of change of user data.

Moreover, since the second server can change automatically the former user data to the new user data in the corresponding one of the lists, a specific procedure for changing user data registered in the list is unnecessary.

In the system according to the first aspect of the present invention, the first and second servers may be configured in separate computers (or other devices) or may be built in a single computer (or another device).

In a preferred embodiment of the system according to the first aspect of the invention, the first server has a means for encrypting the notification of user data change and the second server has a means for decoding the notification of user data change encrypted.

In another preferred embodiment of the system according to the first aspect of the invention, the first server has a means for authenticating the user who made the request when receiving the request.

In still another preferred embodiment of the system according to the first aspect of the invention, when the corresponding one of the lists is not set to be changeable, the change from the former user data to the new user data in the corresponding one of the lists is realizable according to an instruction from a user of the corresponding one of the lists.

In a further preferred embodiment of the system according to the first aspect of the invention, the reception designation service is a service of selectively refusing reception of undesired incoming e-mail messages transmitted from non-permitted e-mail addresses according to the reception designation service lists. Alternately, the reception designation service may be a service of selectively allowing reception of incoming e-mail messages transmitted from permitted e-mail addresses according to the reception designation service lists.

In a still further preferred embodiment of the system according to the first aspect of the invention, the user data is an e-mail address.

In a still further preferred embodiment of the system according to the first aspect of the invention, the reception designation service lists are stored in a database, and the second server has a capability of retrieving the database.

According to a second aspect of the present invention, a method of automatically changing user data in a reception designation service is provided, which comprises:

providing reception designation service lists for storing user data of each of users of a reception designation service, the lists being stored in a database;

receiving a request from a terminal device, the request containing a change from a former user data to a new user data; and

retrieving the database to find the former user data in the lists according to the request;

wherein when the former user data is found in at least one of the lists and the at least one of the lists has been set to be automatically changeable, the former user data found is automatically changed to the new user data without confirmation of a corresponding one or ones of the users to the at least one of the lists.

With the method of automatically changing user data in a reception designation service according to the second aspect of the present invention, reception designation service lists are provided for storing user data of each of users of a reception designation service, the lists being stored in a database. Then, a request from a terminal device is received, the request containing a change from a former user data to a new user data. At this time or thereafter, the database is retrieved to find the former user data in the lists according to the request. When the former user data is found in at least one of the lists and at the same time, the at least one of the lists has been set to be automatically changeable, the former user data thus found is automatically changed to the new user data without confirmation of a corresponding one or ones of the users to the at least one of the lists.

Accordingly, user data (e.g., e-mail address and/or telephone number) registered in the reception designation list of each related user of the reception designation service can be automatically changed according to the request for user data change.

Moreover, since the former user data is automatically changed to the new user data in the at least one of the lists which has been set to be automatically changeable, a specific procedure for changing user data registered in the list or lists is unnecessary.

In a preferred embodiment of the method according to the second aspect of the invention, when the at least one of the lists has not been set to be automatically changeable, the change from the former user data to the new user data in the at least one of the lists is realizable according to an instruction from a user or users of the at least one of the lists.

In a further preferred embodiment of the method according to the second aspect of the invention, the reception designation service is a service of selectively refusing reception of undesired incoming e-mail messages transmitted from non-permitted e-mail addresses according to the reception designation service lists. Alternately, the reception designation service may be a service of selectively allowing reception of incoming e-mail messages transmitted from permitted e-mail addresses according to the reception designation service lists.

In a still further preferred embodiment of the method according to the second aspect of the invention, the user data is an e-mail address.

According to a third aspect of the present invention, another system for automatically changing user data in a reception designation service is provided, which comprises:

reception designation service lists for storing user data of each of users of a reception designation service, the lists being stored in a database;

a first means for receiving a request from a terminal device, the request containing a change from a former user data to a new user data; and

a second means for retrieving the database to find the former user data in the lists according to the request;

wherein when the former user data is found in at least one of the lists and the at least one of the lists has been set to be automatically changeable, the former user data found is automatically changed to the new user data without confirmation of a corresponding one or ones of the users to the at least one of the lists.

With the system of automatically changing user data in a reception designation service according to the third aspect of the present invention, reception designation service lists are provided for storing user data of each of users of a reception designation service, the lists being stored in a database. A first means receives a request from a terminal device, the request containing a change from a former user data to a new user data. A second means retrieves the database to find the former user data in the lists according to the request. When the former user data is found in at least one of the lists and at the same time, the at least one of the lists has been set to be automatically changeable, the former user data thus found is automatically changed to the new user data without confirmation of a corresponding one or ones of the users to the at least one of the lists.

Accordingly, user data (e.g., e-mail address and/or telephone number) registered in the reception designation list of each related user of the reception designation service can be automatically changed according to the request for user data change.

Moreover, since the former user data is automatically changed to the new user data in the at least one of the lists which has been set to be automatically changeable, a specific procedure for changing user data registered in the list or lists is unnecessary.

In a preferred embodiment of the system according to the third aspect of the invention, when the at least one of the lists has not been set to be automatically changeable, the change from the former user data to the new user data in the at least one of the lists is realizable according to an instruction from a user or users of the at least one of the lists.

In a further preferred embodiment of the system according to the third aspect of the invention, the reception designation service is a service of selectively refusing reception of undesired incoming e-mail messages transmitted from non-permitted e-mail addresses according to the reception designation service lists. Alternately, the reception designation service may be a service of selectively allowing reception of incoming e-mail messages transmitted from permitted e-mail addresses according to the reception designation service lists.

In a still further preferred embodiment of the system according to the third aspect of the invention, the user data is an e-mail address.

In the system according to the third aspect of the present invention, the first and second means may be configured in separate computers (or other devices) or may be built in a single computer (or another device).

### BRIEF DESCRIPTION OF THE DRAWINGS

In order that the present invention may be readily carried into effect, it will now be described with reference to the accompanying drawings.

FIG. 1 is a functional block diagram showing the configuration of a mobile terminal device used in an automatic user-data changing system according to an embodiment of the invention.

FIG. 2 is a schematic diagram showing the processes of changing the user data of the user A in the automatic user-data changing system according to the embodiment of the invention.

FIG. 3 is a schematic diagram showing the contents of receiving the reception designation service in the automatic user-data changing system according to the embodiment of the invention, where the user B requests and receives the said service.

FIG. 4 is a schematic diagram showing an example of the interface of a mobile terminal device used in the automatic user-data changing system according to the embodiment of the invention.

FIG. 5 is a sequence diagram showing the operation sequence of changing the e-mail address from the mobile terminal device of the user A to the first server in the automatic user-data changing system according to the embodiment of the invention.

FIG. 6 is a sequence diagram showing the operation sequence of automatically changing the e-mail address of the user A in the reception designation list of the user B in the automatic user-data changing system according to the embodiment of the invention.

FIG. 7 is a flowchart showing the operation flow of the second server in the automatic user-data changing system according to the embodiment of the invention when the second server receives the notification of e-mail address change from the first server.

FIG. 8 is a sequence diagram showing the operation sequence between the second server and the terminal device of the user B in the automatic user-data changing system according to the embodiment of the invention when the second server transmits an e-mail message for notifying the e-mail address change of the user A to the user B, where the reception designation list of the user B was not set to be automatically changeable.

FIG. 9A is a schematic diagram showing an example of the contents (before change) of the reception designation list of the user B used in the automatic user-data changing system according to the embodiment of the invention.

FIG. 9B is a schematic diagram showing an example of the contents (after change) of the reception designation list of the user B used in the automatic user-data changing system according to the embodiment of the invention.

### DETAILED DESCRIPTION OF THE PREFERRED EMBODIMENTS

Preferred embodiments of the present invention will be described in detail below while referring to the drawings attached.

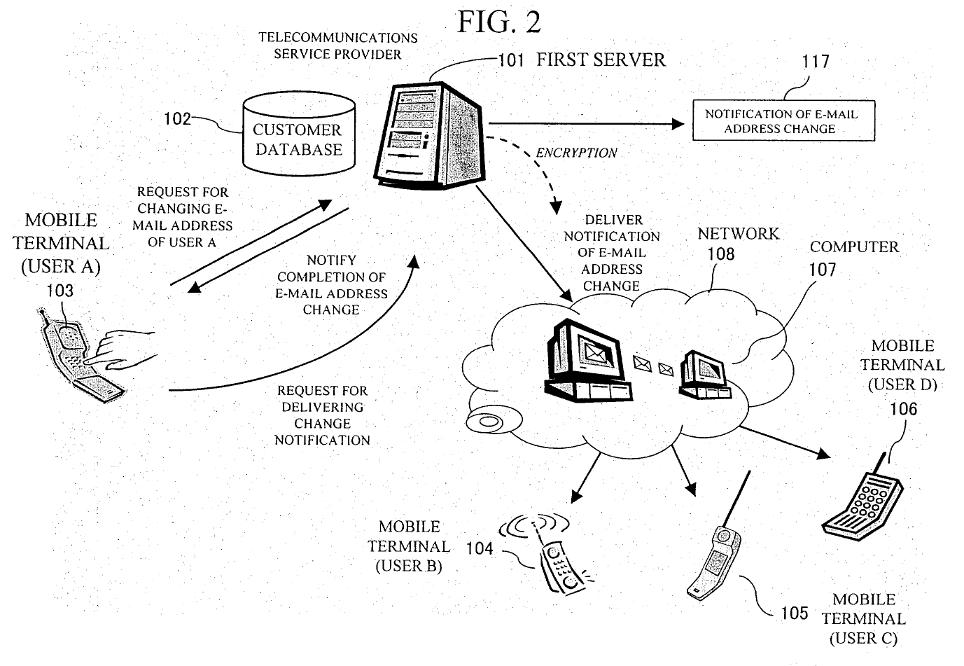

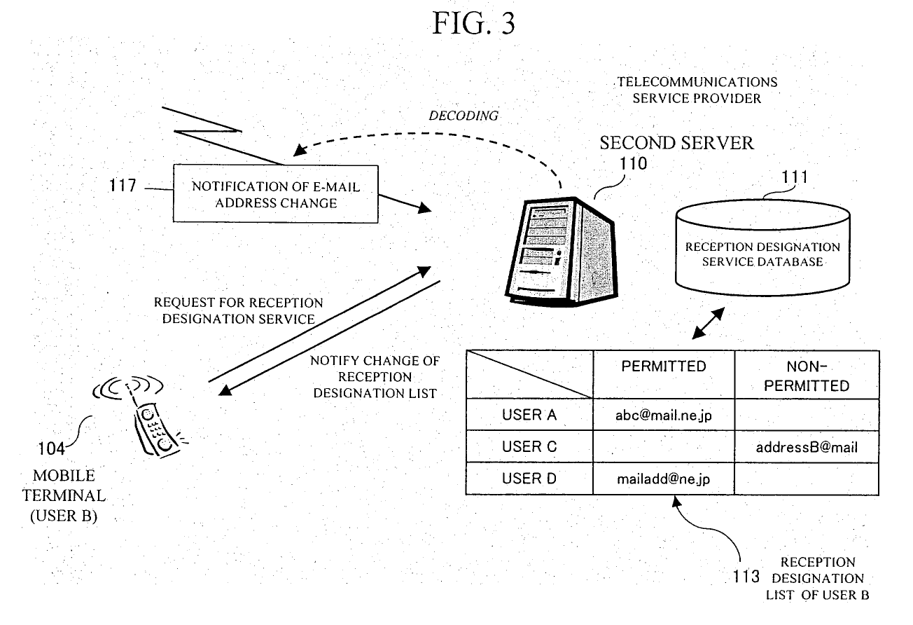

As shown in FIGS. 2 and 3, an automatic user-data changing system according to an embodiment of the invention comprises a first server 101 having a customer database 102, and a second server 110 having a reception designation service database 111. The first and second servers 101 and 110 are established by a telecommunications service provider. Mobile terminal devices 103, 104, 105, and 106 are connectable to the first and/or second server(s) 101 and/or 110 by radio directly or by way of a network for data transmission.

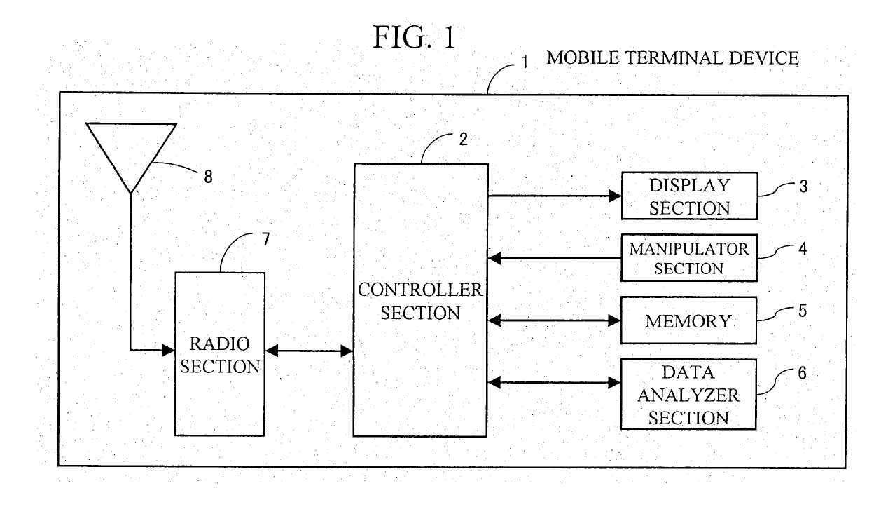

FIG. 1 shows the configuration of a mobile terminal device 1 used in the automatic user-data changing system according to the embodiment of the invention. Each of the terminal devices 103, 104, 105, and 106 has the same configuration as shown in FIG. 1.

As shown in FIG. 1, the mobile terminal device 1 comprises an antenna 8, a radio section 7, a controller section 2, a display section 3, a manipulator section 4, a memory section 5, and a data analyzer section 6. The device 1 is configured as a portable or cellular telephone having a data transmission facility along with an ordinary telephone function.

The radio section 7 is formed by a radio frequency (RF) transmission and reception circuit, which comprises a RF amplifier, a band-pass filter, and so on. The section 7 receives a signal or data transmitted from the outside by radio by way of the antenna 8 or transmits a desired signal or data generated in the section 7 to the outside by radio by way of the antenna 8 according to the necessity.

The controller section 2 comprises a CPU (Central Processing Unit) having a ROM (Read-Only Memory) for storing a control program therein and a RAM (Random-Access Memory) used as a temporary memory region. The section 2 controls each element of the device 1 as necessary.

The display section 3 comprises a LCD (Liquid-Crystal Display) device that provides a display screen. Various images and/or information are displayable on the screen. The section 3 provides a user interface.

The manipulator section 4 comprises a set of manipulation buttons (not shown) to be pressed by the user.

The memory section 5 comprises a rewritable nonvolatile memory, which is used for temporarily storing reception data, and for storing used data (e.g., telephone number and/or e-mail address) inputted by the user by way of the manipulator section 4, and other data. The data stored in the section 5 is read out by the controller section 2 and displayed on the screen of the display section 3 according to the necessity.

The data analyzer section 6 analyzes the contents of notifications, instructions, data and/or files received by way of the antenna 8 and the radio section 7.

FIG. 2 shows the processes of changing user data in the automatic user-data changing system according to the embodiment of the invention.

A mobile terminal device 103, which is used by the user A, has the same configuration as that of the device 1 shown in FIG. 1. The device 103 is connectable by radio directly or by way of a network (not shown) to the first server 101 established by the telecommunications service provider. The first server 101, which is configured by a computer, comprises a customer database 102 for storing the customer data (e.g., the name, address, telephone number, and e-mail address) of the customers of the provider.

When the user A wants to change his/her e-mail address stored in the customer database 102, the user A connects his/her terminal device 103 to the first server 101 by radio and then, transmits a request for changing the e-mail address to the server 101 from the terminal device 103. When the server 101 receives the request, the server 101 changes the e-mail address of the user A stored in the database 102 according to the request. After the changing operation of the e-mail address is normally completed, the server 101 transmits by radio a notification of completion of the requested e-mail address change to the terminal device 103. At the same time, the server 101 transmits a notification 117 of the e-mail address change of the user A to the second server 110 shown in FIG. 3.

In response to the notification 117 of the e-mail address data change of the user A, the user A manipulates the manipulator section 4 of the terminal device 103 to transmit by radio a request for delivering a notification of the e-mail address change to the first server 101. This request is made to notify the fact that the e-mail address of the user A was changed to terminal devices of the people concerned. The terminal devices of the people concerned are designated in the request by the user A. Here, for the sake of simplification, the mobile terminal device 104 for the user B, the mobile terminal device 105 for the user C, and the mobile terminal device 105 for the user D are only shown as the terminal devices of the people concerned.

In response to the request for delivering a notification of the e-mail address change from the user A, the first server 101 delivers e-mail messages to the people concerned (i.e., the users B, C, and D of the mobile devices 104, 105, and 106) as the said notification by way of a computer network 108. The terminal devices 104, 105, and 106, which are respectively used by the users B, C, and D, are connectable by radio to the first server 101 by way of the network 108. Each of the devices 104, 105, and 106 has the same configuration as that of the device 1 shown in FIG. 1. The network 108 is formed by computers 107 connected to each other.

When the notification of the e-mail address change of the user A is delivered, the first server 101 applies a specific encryption process (e.g., an encryption for electronic signature, common key system, or public key system) to the said notification for security. Thus, the users B, C, and D can know the e-mail address change of the user A promptly.

FIG. 3 shows the contents of the “reception designation service” in the automatic user-data changing system according to the embodiment of the invention. Here, explanation about the terminal device 104 of the user B is only presented, because the same explanation is applicable to the other terminal devices 105 and 106 of the users C and D.

When the user B wants to receive the “reception designation service” provided by the telecommunications service provider, the user B connects his/her terminal device 104 to the second server 110 established by the provider by radio and then, transmits a request for receiving the “reception designation service” to the server 110 on the terminal device 104. The server 110, which is configured by a computer, has a reception designation service database 111 for storing reception designation lists for the respective users of this service. After receiving the request for receiving the said service from the user B, the server 110 creates a reception designation list 113 for the user B in the database 111. An example of the list 113 for the user B is additionally shown in FIG. 3.

As seen from FIG. 3, the reception designation list 113 for the user B contains “permitted e-mail addresses” of the users A and D and a “non-permitted e-mail address” of the user C. If an e-mail message transmitted to the user B by way of the telecommunications service provider includes the permitted address “abc@mail.ne.jp” of the user A or “mailadd@ne.jp” of the user D as the sender's address, the said e-mail message is transmitted to the user B as the recipient. On the other hand, if an e-mail message transmitted to the user B by way of the provider includes the non-permitted address “address@mail” of the user C as the sender's address, the said e-mail message is not transmitted to the user B as the recipient. In this way, the user B can selectively receive incoming e-mail messages according to the contents of the reception designation list 113 for the user B. In other words, the user B can screen his/her incoming e-mail messages by designating unwanted e-mail addresses in the list 113.

As described above, after the first server 101 changes the e-mail address of the user A stored in the customer database 102 according to the request from the user A, the first server 101 transmits the notification 117 for notifying the e-mail address change of the user to the second server 110. When the second server 110 receives the notification 117, the server 110 decodes the notification 117 which has been encrypted by the first sever 101, thereby recognizing the contents of the notification 117.

If the reception designation list 113 for the user B has been set to be automatically changeable, the second server 110 analyzes the contents of the notification 117 to know the fact that the user A changed his/her former e-mail address to a new one. Thereafter, the server 110 automatically retrieves the reception designation service database 111 to find the former e-mail address of the user A in the reception address designation list 113 for the user B. Subsequently, the server 110 automatically changes the former e-mail address of the user A to the new one.

On the other hand, if the reception designation list 113 for the user B has not set to be automatically changeable, the second server 110 automatically transmits a notification for notifying the change of the e-mail address of the user A to the terminal device 104 of the user B, thereby instructing the user B to manually change the former e-mail address of the user A to the new one in his/her list 113. In this case, the server 110 does not analyze the said notification 117 and does not retrieve the designation service database 111.

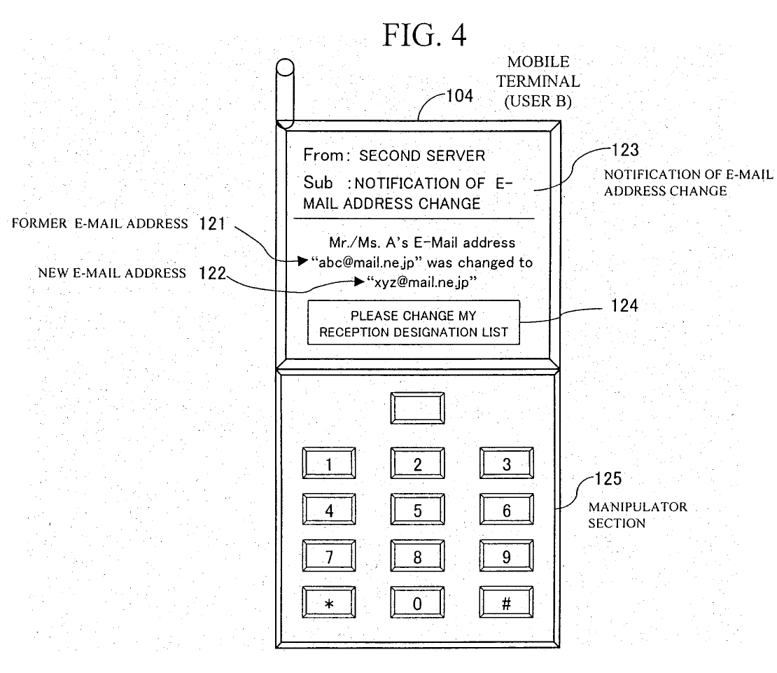

FIG. 4 shows an example of the interface of the mobile terminal device 104 for the user B.

When the reception designation list 113 for the user B stored in the reception designation service database 111 is set to be automatically unchangeable, the second server 110 automatically transmits a notification of the e-mail address change of the user A to the terminal device 104 of the user B after decoding the notification 117 sent from the first server 101. This is to instruct the user B to manually change the former e-mail address of the user A to the new one in the reception designation list 113 for the user B.

The reference numeral 123 in FIG. 4 denotes the notification of the e-mail address change of the user A, which is displayed on the screen of the terminal device 104. This notification 123 includes the former e-mail address 121 and the new e-mail address 122 of the user A.

After receiving the notification 123 by the terminal device 104, the user B manipulates the buttons of the manipulator section 125 to press an instruction button 124 displayed on the screen. As a result, to change the former e-mail address of the user A to the new one in the B's list 113, a request for changing the list 113 is transmitted from the terminal device 104 to the second server 110.

In response to this request, the second server 110 checks whether the user B has received the reception designation service or not. Here, the user B has already received the reception designation service and therefore, the server 110 then retrieves the reception designation service database 111 to find the former e-mail address 121 in the reception designation list 113 of the user B. Subsequently, the server 110 changes the former e-mail address 121 to the new e-mail address 122 as shown in FIG. 4.

After the said changing operation is completed, the server 110 transmits a notification of completion of the e-mail address change by e-mail to the terminal device 104 of the user B. As a result, the user B can know the completion of the e-mail address change in, the reception designation list 113 of the user B as desired.

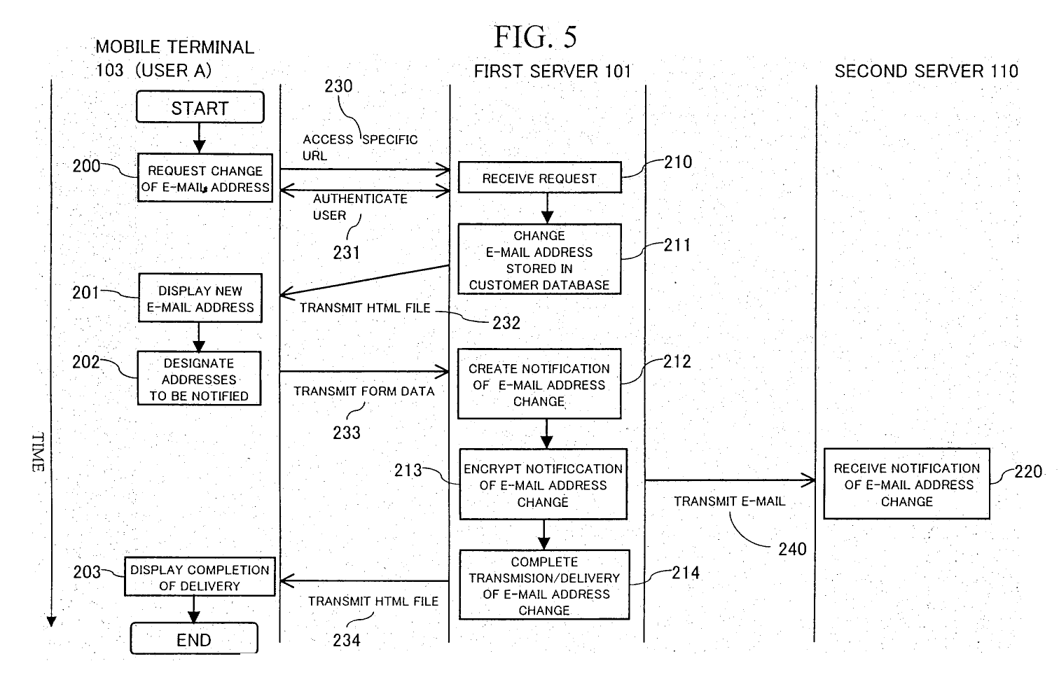

FIG. 5 shows the detailed operation sequence of changing the e-mail address in the first server 101, which is shown in FIG. 2 and carried out by the user A with his/her terminal device 103, in the automatic user-data changing system according to the embodiment of the invention.

First, the user A accesses a specific URL (Uniform Resource Locator) to connect the terminal device 103 to the first server 101 by radio (step 230). In response, the first server 101 checks whether the user A is a subscriber of the telecommunications service provider using specific authentication information such as the password or ID (Identification) number (step 231). After the server 101 confirmed that the user A is a subscriber or member of the provider, the user A transmits a request for changing his/her former e-mail address to a new one to the first server 101 with the terminal device 103 (step 200). The first server 101 receives the said request (step 210) and changes the former e-mail address of the user A to a new one in the relating reception designation lists 113 stored in the customer database 102 according to the request (step 211).

After the change of the e-mail address of the user A in the relating lists 113 is completed, the first server 101 transmits a HTML (Hypertext, Markup Language) file for notifying the terminal device 103 the completion of the requested e-mail address change and the new e-mail address. According to the HTML file thus transmitted, the terminal device 103 displays the notification of the completion of the e-mail address change and the new e-mail address on its screen (step 201), thereby notifying them to the user A.

Subsequently; the user A manipulates the buttons of the manipulator section 4 on the device 103, thereby designating the e-mail addresses to which the user A wants to notify the change of his/her e-mail address and the new e-mail address in a specific form (step 202). Then, the user A transmits the first server 101 the form data designating the e-mail addresses to be notified from the device 103 (step 233)

In response to the form data thus transmitted, the first server 101 creates the notification 117 of e-mail address change (step 212), encrypts the notification 117 thus created by way of an encryption process such as electronic signature, common key system, public key system or the like (step 213), and transmits the notification 117 to the second server 110 in the form of e-mail (step 240). After receiving the notification 117 (step 220), the second server 110 conducts the operation for changing the contents of the reception designation lists 113 according to the setting (i.e., automatically changeable or not) of the respective lists 113.

On the other hand, the server 101 creates a notification for notifying the e-mail address change of the user A, encrypts the notification thus created by way of an encryption process such as electronic signature, common key system, public key system or the like, and delivers the notification in the form of e-mail to the designated e-mail addresses by the user A by way of the network 108, as shown in n FIG. 2. This is to notify the e-mail address change of the user A to all the designated recipients.

When the notification (i.e., the e-mail message) for notifying the e-mail address change of the user A is normally delivered to the designated recipients while the notification 117 is normally transmitted to the second server 110, the first server 101 completes the delivering operation of the notification and the transmission operation of the notification 117 (step 214). Thereafter, the server 101 transmits a HTML file for notifying the completion of delivery of the notification to the terminal device 103 of the user A.

According to the HTML file thus transmitted, the terminal device 103 displays the notification of the completion of the delivery of the e-mail address change on its screen (step 203). By looking at the displayed image on the screen, the user A confirms that the desired change of his/her e-mail address has been completed in the first server 101 and then, finishes the serial operation for changing his/her e-mail address.

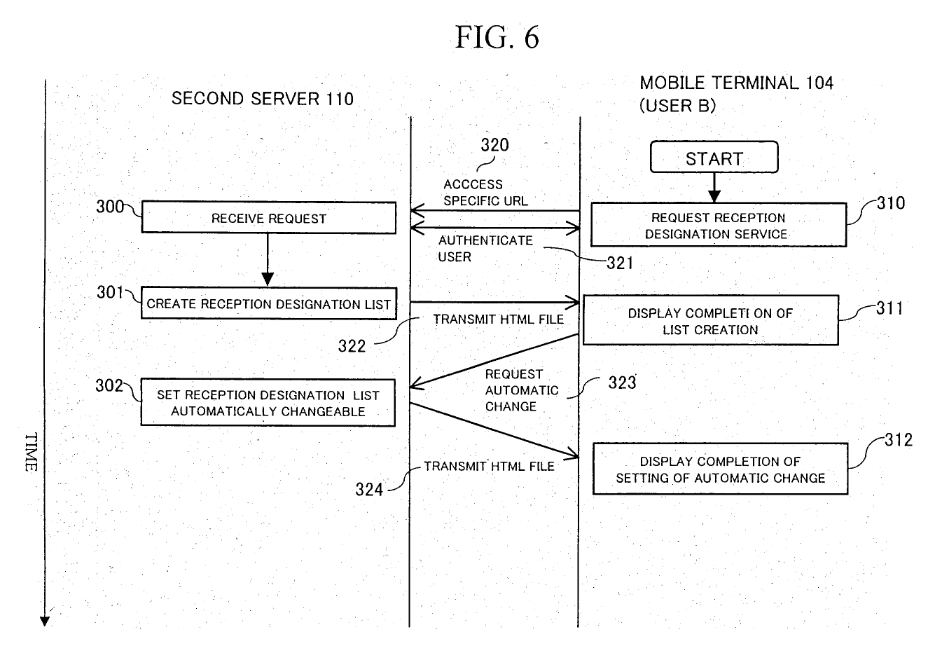

FIG. 6 shows the operation sequence of automatically changing the e-mail address of the user A in the reception designation list 113 of the user B in the automatic user-data changing system according to the embodiment of the invention.

First, the user B accesses a specific URL with the terminal device 104 to connect the second server 110 by radio (step 320). In response, the second server 110 checks whether the user B is a subscriber or member of the reception designation service using authentication information such as the password or ID number (step 321). This access may be carried out any time the user B wants to receive the reception designation service. After the server 110 judges the user B is a subscriber or member of the provider, the user B transmits a request for receiving the reception designation service of the telecommunications service provider to the second server 110 from the terminal device 104 (step 310). The request contains the designation of permitted e-mail addresses and non-permitted (i.e., prohibited) e-mail addresses as the sender's address.

The second server 110 receives the request for receiving the said service from the user B (step 300) and thereafter, creates the reception designation list 113 for the user B in the reception designation service database 111 (step 301).

After the creation of the reception designation list 113 for the user B is completed, the second server 110 transmits a HTML file for notifying the completion of the creation of the list 113 to the terminal device 104. According to the HTML file, the terminal device 104 displays the completion of the creation of the list 113 on its screen (step 311), thereby notifying it to the user B.

The same process steps as above are carried out whenever the reception designation list 113 for the user B is renewed in the future.

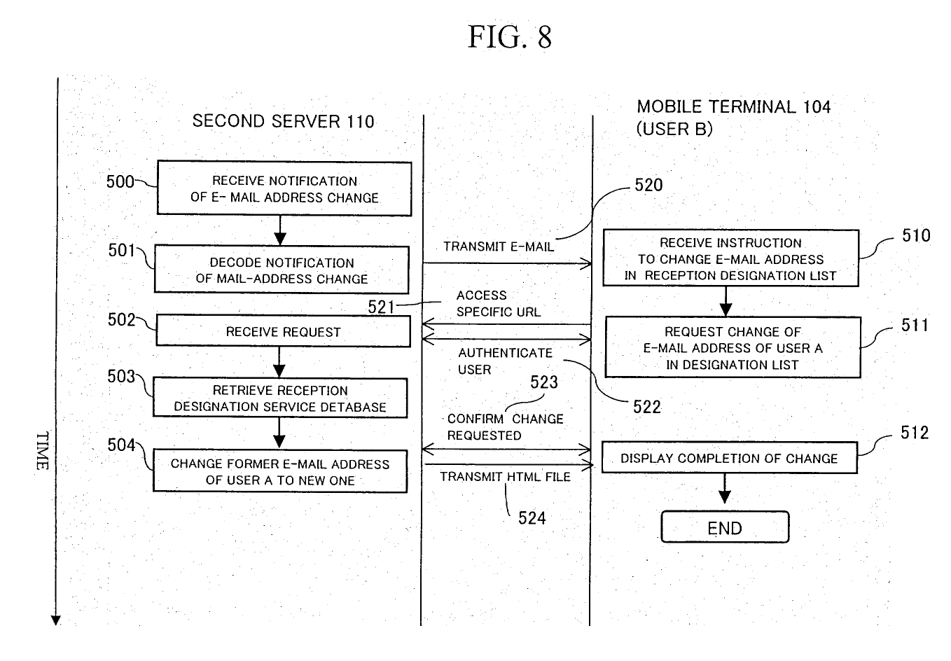

Subsequently, if desired, the user B manipulates the buttons of the manipulator section 4 on the device 104, thereby requesting the “automatic change” service of his/her own reception designation list 113 to the second server 110 (step 323). This automatic change service is a service that when the second server 110 receives the notification 117 of e-mail address change transmitted from the first server 101, the second server 110 changes automatically the e-mail address or addresses registered in the list 113 according to the instruction by the notification 117 without confirmation of the owner of the list 113 (i.e., the user B), if the list 113 is set to be automatically changeable. If the list 113 is not set to be automatically changeable the second server 110 notifies the e-mail address change of the user A to the user B and then, encourages the user B to manually change the list 113 according to the said notification. The operation in this case will be explained later with reference to FIG. 8.

In response to the request for the “automatic change” service from the user B, the second server 110 sets the reception designation list 113 of the user B stored in the reception designation service database 111 automatically changeable (step 302). Thereafter, the server 110 transmits a HTML file for notifying the completion of the setting of the automatic change service of the list 113 to the terminal device 104. According to the HTML file, the terminal device 104 displays the notification of the completion of the setting of the automatic change service of the list 113 on its screen (step 312), thereby notifying it to the user B.

The same process steps as above are carried out when the automatic change service of the list 113 is cleared or reset in the future.

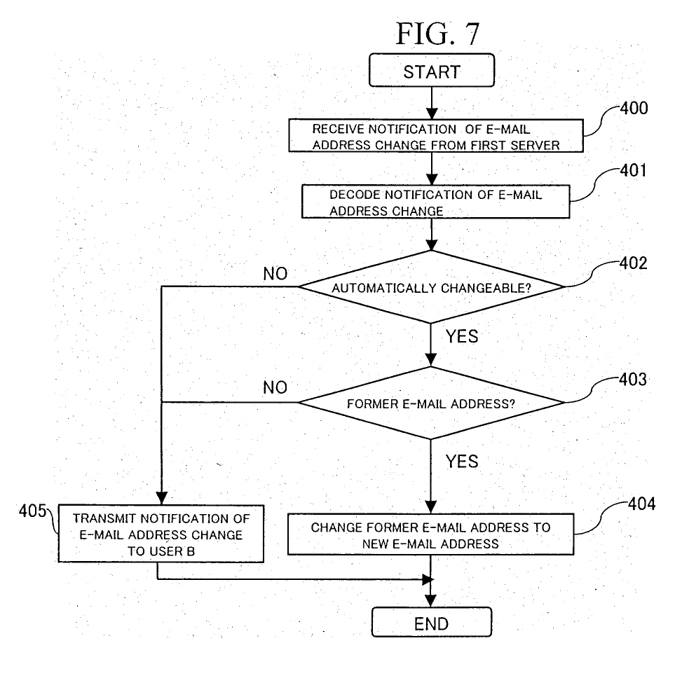

FIG. 7 shows the operation flow of the second server 110 in the automatic user-data changing system according to the embodiment of the invention when the second server 110 receives the notification 117 of e-mail address change from the first server 101.

The second server 110 receives the notification 117 of e-mail address change transmitted from the first server 101 (step 400) and then, decodes the notification 117 to clear the encryption applied to the notification 117 (step 401). Thereafter, the server 110 judges whether the reception designation list 113 of the user B is set to be automatically changeable (step 402).

When the list 113 of the user B is not set to be automatically changeable in the step 402, the flow is jumped to the step 405 where a notification that notifies the fact that the e-mail address of the user A was changed is transmitted to the user B in the form ∘ fe-mail. Thereafter, the operation flow is completed.

On the other hand, when the list 113 of the user B is set to be automatically changeable in the step 402, the server 110 analyzes the notification 117 to know its contents, i.e., the former and new e-mail addresses of the user A. Thereafter, the server 110 retrieves the reception designation service database 111 to find the former e-mail address of the user A designated by the notification 117 in the reception designation list 113 of the user B. Thus, the server 110 judges whether the former e-mail address of the user A is included in the list 113 of the user B (step 403).

When the former e-mail address of the user A is not included in the list 113 of the user B in the step 403, the flow is jumped to the step 405, thereby transmitting a notification that notifies the fact that the e-mail address of the user A was changed is transmitted to the user B (step 405). Thereafter, the operation flow is completed.

When the former e-mail address of the user A is included in the list 113 of the user B in the step 403, the second server 110 changes the former e-mail address to the new e-mail address designated by the notification 117 in the list 113 without confirmation of the owner of the list 113, i.e., the user B (step 404). Thereafter, the operation flow is completed.

As explained above, the second server 110 performs the automatic changing operation of the e-mail address in the reception designation lists 113 of the respective users stored in the database 111 according to the notification 117.

FIG. 8 shows the operation sequence between the second server 110 and the terminal device 104 of the user B in the automatic user-data changing system according to the embodiment of the invention, where the second server 110 transmits an e-mail message for notifying the e-mail address change of the user A to the user B because the reception designation list 113 of the user B has not set to be automatically changeable.

The second server 110 receives the notification 117 of e-mail address change transmitted from the first server 101 (step 500) and then, decodes the notification 117 to clear the encryption applied to the notification 117 (step 501). Here, the server 110 recognizes the fact that the reception designation list 113 of the user B was not to be automatically changeable and therefore, the server 110 transmits the terminal device 104 of the user B an e-mail message for instructing the user B to change manually the e-mail address of the user A in his/her reception designation list 113 (step 520).

After the terminal device 104 receives the e-mail message instructing the user B to manually change the e-mail address change of the user A in the list 113 (step 510), the user B accesses a specific URL to connect the device 104 to the second server 110 by radio (step 521). In response, the second server 110 checks whether the user B is a subscriber or member of the automatic changing service using authentication information such as the password or ID number (step 522). This access may be carried out any time the user B wants to request the change of the e-mail address of the user A in the list 113 according to the instruction transmitted from the second server 110.

The second server 110 receives the request of the user B for changing the e-mail address of the user A in the list 113 (step 502) and thereafter, retrieves the reception designation service database 111 to find the instructed former e-mail address of the user A in the list 113 of the user B (step 503). When the server 110 finds the former e-mail address of the user A in the said list 113, the server 110 asks the user B whether the change of the former e-mail address of the user A to the new one is correct or not, thereby confirming the correctness of the e-mail address change requested (step 523).

After the confirmation of the correctness of the e-mail address change requested is completed in the step 523, in other words, after the e-mail address change requested is accepted by the user B the second server 110 changes the former e-mail address of the user A to the new one in the reception designation list 113 of the user B (step 504). After the e-mail address change is completed normally, the server 110 transmits a HTML file to the terminal device 104 of the user B (step 524). In response, the device 104 displays a notification for notifying the fact that the requested e-mail address change has been completed normally on its screen (step 512). As a result, the user B knows the requested change was normally made in his/her list 113. Thus, the operation sequence is finished.

On the other hand, when the e-mail address change is not completed normally in the step 504, the second server 110 transmits a HTML file to the terminal device 104 of the user B in the step 524. In response, the device 104 displays an error message (i.e., a message that the requested e-mail address change was not completed normally) on its screen in the step 512. In this way, the user B knows the requested change was not made normally in the list 113. Thus, the operation sequence is finished.

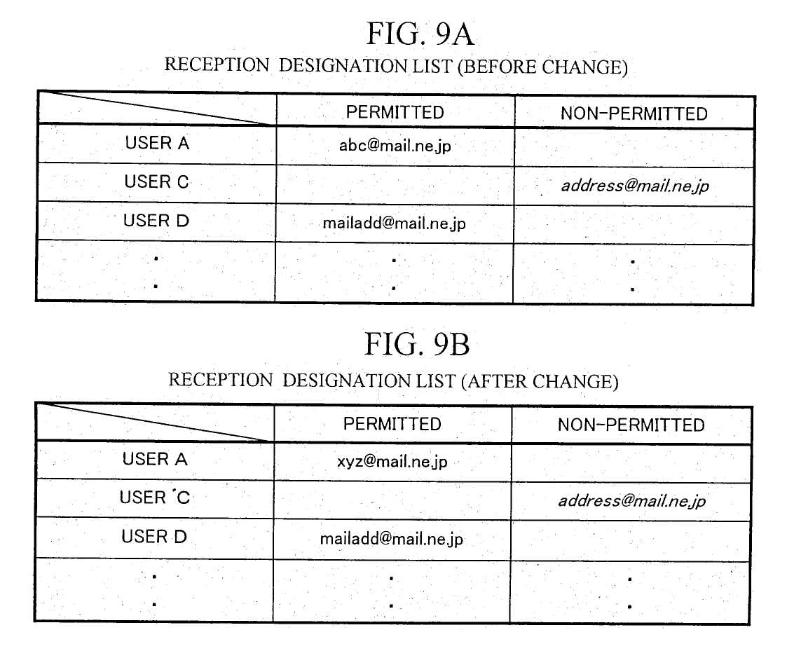

FIGS. 9A and 9B show an example of the contents (before and after change) of the reception designation list 113 of the user B used in the automatic user-data changing system according to the embodiment of the invention, respectively. The list 113 contains permitted and non-permitted e-mail addresses of specific users, all of which were designated by the user B.

In FIGS. 9A and 9B, the e-mail addresses of the users A and D are permitted while the one of the user C is not permitted. According to the request of the user B, the former e-mail address (i.e., abc@mail.ne.jp) of the user A was selectively changed to the new one (i.e., xyz@mail.ne.jp). The other addresses were kept unchanged.

As explained above in detail, with the automatic user-data changing system according to the embodiment of the invention, the reception designation service lists 113 are provided for storing the e-mail address or addresses of each of the users of the reception designation service. The first server 101 has a capability of sending the notification 117 of the e-mail address change of the user A to the second server 110 according to the request from the terminal device 103 of the user A, where the notification contains the change from the former e-mail address to the new one of the user A. The second server 110 has a capability of receiving the notification 117 and of changing the former e-mail address to the new one of the user A in the list 113 of the user B according to the request of the user B. When the list 113 of the user B is set to be automatically changeable, the second server 110 changes automatically the former e-mail address to the new one in the list 113. When the list 113 of the user B is not set to be automatically changeable, the second server 110 notifies the user B the e-mail address change of the user A and encourages the user B to manually changes the former e-mail address of the user A to the new one in the list 113 of the user B.

Accordingly, the e-mail address (which is one of the user data) registered in the reception designation list 113 of the user B of the reception designation service can be automatically changed according to the notification 117 of e-mail address change of the user A.

Moreover, since the second server 110 can change automatically the former e-mail address of the user A to the new one in the list 113 of the user B, a specific procedure for changing the e-mail address of the user A registered in the list 113 is unnecessary.

In the above-described embodiment, the e-mail address is used as the user data. However, the invention is not limited to this. Any other user data (e.g., telephone or facsimile number) may be used for this purpose.

The first and second servers 101 and 110 may be provided by separate telecommunications service providers or by the same telecommunications service provider.

In the above-described embodiment, the user A changes his/her e-mail address with the terminal device 103 and then, this change is reflected to the reception designation list 113 of the user B. However, the invention is not limited to this. For example, the user B (not user A) may change his/her e-mail address with the terminal device 104 and then, this change may be reflected to the reception designation list of the user B himself/herself.

### OTHER EMBODIMENTS

It is needless to say that the invention is not limited to the above-described embodiment. Any modification is applicable to the embodiment. For example, although each of the mobile terminal devices used in the above-described embodiment is configured as a portable radio telephone, any other terminal device may be used if it has a data communication facility for transmitting and receiving e-mail messages and data files and an information display facility for displaying specific notifications to the user. For example, personal computers (PCs) and/or personal digital assistants (PDAs) may be used for this purpose.

Moreover, a piece of information that the user authentication has been finished may be added to the instruction button 124 displayed on the screen shown in FIG. 4. In this case, there is an additional advantage that the step 522 for user authentication shown in FIG. 8 can be omitted.

If the former e-mail address of the user A, which has been requested by the user B to find, is not found in the reception designation list 113 in the step 403 of FIG. 7, the said former e-mail address may be automatically added to the list 113.

While the preferred forms of the present invention have been described, it is to be understood that modifications will be apparent to those skilled in the art without departing from the spirit of the invention. The scope of the present invention, therefore, is to be determined solely by the following claims.

What is claimed is:

1. A system for automatically changing user data, comprising:
reception designation service lists for storing user data of each of users of a reception designation service;
a first server having a capability of sending a notification of user data change according to a request from a terminal device of a user, the notification containing a change from a former user data to a new user data; and
a second server having a capability of receiving the notification and of changing the former user data to the new user data in a corresponding one of the lists to the terminal device according to the notification;
wherein when the corresponding one of the lists is set to be changeable, the second server changes automatically the former user data to the new user data in the corresponding one of the lists.

2. The system according to claim 1, wherein the first server has a means for encrypting the notification of user data change and the second server has a means for decoding the notification of user data change encrypted.

3. The system according to claim 1, wherein the first server has a means for authenticating the user who made the request when receiving the request.

4. The system according to claim 1, wherein when the corresponding one of the lists is not set to be changeable, the change from the former user data to the new user data in the corresponding one of the lists is realizable according to an instruction from a user of the corresponding one of the lists.

5. The system according to claim 1, wherein the reception designation service is a service of selectively refusing reception of undesired incoming e-mail messages transmitted from non-permitted e-mail addresses according to the reception designation service lists.

6. The system according to claim 1, wherein the reception designation service is a service of selectively allowing reception of incoming e-mail messages transmitted from permitted e-mail addresses according to the reception designation service lists.

7. The system according to claim 1, wherein the user data is art e-mail address.

8. The system according to claim 1, wherein the reception designation service lists are stored in a database, and the second server has a capability of retrieving the database.

9. A method of automatically changing user data in a reception designation service, comprising:
providing reception designation service lists for storing user data of each of users of a reception designation service, the lists being stored in a database;
receiving a request from a terminal device, the request containing a change from a former user data to a new user data; and
retrieving the database to find the former user data in the lists according to the request;
wherein when the former user data is found in at least one of the lists and the at least one of the lists has been set to be automatically changeable, the former user data found is automatically changed to the new user data without confirmation of a corresponding one or ones of the users to the at least one of the lists.

10. The method according to claim 9, wherein when the at least one of the lists has not been set to be automatically changeable, the change from the former user data to the new user data in the at least one of the lists, is realizable according to an instruction from a user or users of the at least one of the lists.

11. The method according to claim 9, wherein the reception designation service is a service of selectively refusing reception of undesired incoming e-mail messages transmitted from non-permitted e-mail addresses according to the reception designation service lists.

12. The method according to claim 9, wherein the reception designation service is a service of selectively allowing reception of incoming e-mail messages transmitted from permitted e-mail addresses according to the reception designation service lists.

13. The method according to claim 9, wherein the user data is an e-mail address.

14. A system for automatically changing user data in a reception designation service, comprising:
reception designation service lists for storing user data of each of users of a reception designation service, the lists being stored in a database;
a first means for receiving a request from a terminal device, the request containing a change from a former user data to a new user data; and
a second means for retrieving the database to find the former user data in the lists according to the request;
wherein when the former user data is found in at least one of the lists and the at least one of the lists has been set to be automatically changeable, the former user data found is automatically changed to the new user data without confirmation of a corresponding one or ones of the users to the at least one of the lists.

15. The method according to claim 14, wherein when the at least one of the lists has not been set to be automatically changeable the change from the former user data to the new user data in the at least one of the lists is realizable according to an instruction from a user or users of the at least one of the lists.

16. The method according to claim 14, wherein the reception designation service is a service of selectively refusing reception of undesired incoming e-mail messages transmitted from non-permitted e-mail addresses according to the reception designation service lists.

17. The method according to claim 14, wherein the reception designation service is a service of selectively allowing reception of incoming e-mail messages transmitted from permitted e-mail addresses according to the reception designation service lists.

18. The method according to claim 14, wherein the user data is an e-mail address.
